(19) United States
(12) Patent Application Publication
(10) Pub. No.: US 2008/0152978 A1
(43) Pub. Date: Jun. 26, 2008

(54) Highly Hydrophilic Support, Catlyst- Supporting Support, Electrode for Fuel Cell, Method for Producing the Same, and Polymer Electrolyte Fuel Cell Including the Same

(75) Inventors: Hiroshi Hamaguchi, Toyota-shi (JP); Akira Tsujiko, Toyota-shi (JP); Masahiro Ueda, Kyoto-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 11/659,096

(22) PCT Filed: Aug. 1, 2005
(86) PCT No.: PCT/JP05/14473

§ 371 Date: May 30, 2007

(30) Foreign Application Priority Data
Aug. 5, 2004 (JP) 2004-229707

(51) Int. Cl. H01M 8/10; B01J 32/00; B32B 3/26

(52) U.S. Cl. 429/30; 502/439; 428/304.4; 428/308.4; 429/12

(57) ABSTRACT

A method for producing a catalyst-supporting support made up of catalyst-supporting carbon and an electrolyte polymer is provided which is characterized by including: a step of allowing carbon with pores to support a catalyst; a step of introducing a functional group, which is to be a polymerization initiator, into the surface and/or the pores of the catalyst-supporting carbon; and a step of introducing an electrolyte monomer or electrolyte monomer precursor into the surface and/or the pores of the catalyst-supporting carbon to polymerize the introduced electrolyte monomer or electrolyte monomer precursor using the polymerization initiator as a polymerization initiation site, whereby a three-phase boundary at which the reaction gas, catalyst and electrolyte meet can be sufficiently ensured in the carbon, and thus the catalyst can be more efficiently utilized. The use of the catalyst-supporting support enables electrode reactions to progress efficiently and the efficiency of power generation of a fuel cell to be increased. Further, the use of the catalyst-supporting support makes it possible to provide an electrode having excellent characteristics and a polymer electrolyte fuel cell including the electrode with which high output can be obtained.

### TECHNICAL FIELD

The present invention relates to a highly hydrophilic support, a catalyst-supporting support, an electrode for a fuel cell, a method for producing the same, and a polymer electrolyte fuel cell including the same.

### BACKGROUND ART

Polymer electrolyte fuel cells having a polymer electrolyte membrane are easy to make compact-size and light-weight and are thus expected to come in practice as power sources for vehicles such as electric vehicles or small-scale cogeneration systems.

The electrode reactions in the catalyst layers of anode and cathode of a polymer electrolyte fuel cell progress at three-phase boundaries (hereinafter referred to as reaction sites) where reaction gas, catalyst and fluorine-containing ion-exchange resin (electrolyte) meet. Thus, in polymer electrolyte fuel cells, catalysts, such as metal-supporting carbon produced by allowing carbon black having a large specific surface area to support a metal catalyst such as platinum, with the same or different kind of fluorine-containing ion exchange resin from that of the polymer electrolyte membrane coated thereon have been traditionally used as a constituent of the catalyst layers.

As described above, the generation of protons and electrons at the anode is carried out in the meetence of three phases: catalyst, carbon particles and electrolyte. Specifically, hydrogen gas is reduced due to the meetence of a proton-conducting electrolyte, electron-conducting carbon particles and a catalyst. Accordingly, the larger the amount of the catalyst supported on the carbon particles, the higher the efficiency of the power generation. The same is true for the cathode. However, increasing the amount of the catalyst supported on carbon particles poses the problem of increasing the manufacturing cost of a fuel cell, since the catalyst used for a fuel cell is noble metal such as platinum.

Traditionally, catalyst layers have been formed by: casting an ink, which is a dispersion of an electrolyte such as Nafion (brand name) and catalyst powder such as platinum or carbon in a solvent, and drying the cast ink. In catalyst powder, many of its pores are several tens nm in size. This, presumably, inhibits an electrolyte, which is a polymer and therefore a large molecule, from entering the nano-size pores and only allows it to cover the surface of the catalyst powder. Thus, the platinum in the pores are not effectively used, which contributes to the lowering of catalyst performance.

To overcome the above described disadvantages of the conventional art, specifically to improve the efficiency of the power generation while avoiding increasing the amount of catalyst supported on carbon particles, there is disclosed, in Japanese Patent Laid-Open No. 2002-373662, a method for producing an electrode for a fuel cell which includes the steps of: preparing an electrode paste by mixing catalyst-supporting particles which support catalyst particles on their surface and an ion-conducting polymer; treating the prepared electrode paste in a solution containing catalyst metal ions to subject the catalyst metal ions to ion exchange with the ion conducting polymer; and reducing the catalyst metal ions.

On the other hand, to produce an ion-exchange membrane having sufficiently resistant to heat and chemicals while avoiding defects, there is disclosed, in Japanese Patent Laid-Open No. 6-271687, a method for producing an ion-exchange membrane which includes the steps of: impregnating a substrate made up of a fluorine polymer with polymerizable monomer to allow the substrate to support the polymerizable monomer; allowing part of the polymerizable monomer to react at the first stage by exposing the polymerizable monomer to ionizing radiation and allowing the rest of the polymerizable monomer to polymerize at the second stage by heating the same in the presence of a polymerization initiator; and if necessary, introducing an ion-exchange group into the resultant polymer, the method being characterized by specifying the radiation dose of the ionizing radiation to which the polymerizabie monomer is exposed at the first stage.

### DISCLOSURE OF THE INVENTION

However, in the method disclosed in Japanese Patent Laid-Open No. 2002-373662, even if the electrode paste is treated as described above, there is a limit to improving the efficiency of the power generation. This is because catalyst-supporting carbon has pores on the order of nanometers which a large molecule such as polymer cannot go into, and therefore the catalyst such as platinum adsorbed on the surface of such pores cannot form a three-phase boundary as described above, in other words, the catalyst cannot be a reaction site. Thus, the problem with the method is that electrolyte polymer cannot go into the pores of carbon particles.

In the method disclosed in Japanese Patent Laid-Open No. 6-271687, which is a method for producing an ion-exchange membrane, operations such as exposing the polymerizable monomer to radiation are not easy.

The present invention has been made in the light of the above described problems with conventional art. Accordingly, an object of the present invention is to ensure a three-phase boundary, where reaction gas, catalyst and electrolyte meet, in carbon particles to improve catalyst efficiency. Another object of the present invention is to allow electrode reaction to progress efficiently by improving catalyst efficiency, thereby increasing the efficiency of the power generation of the fuel cell. Still another object of the present invention is to provide an electrode having excellent characteristics and a polymer electrolyte fuel cell that includes such an electrode and thus can produce high cell output. It is to be understood that the application of the present invention is not limited to polymer electrolyte fuel cell field, but it can be widely applied to various types of catalysts that employ carbon support.

The present inventors have found that the above described problems can be solved by producing a polymer electrolyte in situ in the pores on the order of nanometers in carbon particles using the living polymerization technique, and they have finally made the present invention.

Specifically, a first aspect of the present invention is a method for producing a highly hydrophilic support made up of a carbon support and an electrolyte polymer, characterized in that the method includes a step of introducing a functional group, which is to be a polymerization initiator, into the surface and/or the pores of the carbon support with pores; and a step of introducing an electrolyte monomer or electrolyte monomer precursor into the surface and/or the pores of the carbon support to polymerize the electrolyte monomer or electrolyte monomer precursor using the above described polymerization initiator as a polymerization initiation site. The catalyst-supporting support of the present invention is highly hydrophilic because its surface is coated with a thin coat of a polymer electrolyte. Thus, it does not aggregate, but exhibits high dispersibility in water.

A second aspect of the present invention is a method for producing a catalyst-supporting support made up of catalyst-supporting carbon and an electrolyte polymer, characterized in that the method includes a step of allowing carbon with pores on the order of nanometers to support a catalyst; a step of introducing a functional group, which is to be a polymerization initiator, into the surface and/or the pores of the above catalyst-supporting carbon; and a step of introducing an electrolyte monomer or electrolyte monomer precursor into the surface and/or the pores of the carbon support to polymerize the electrolyte monomer or electrolyte monomer precursor using the above described polymerization initiator as a polymerization initiation site. This allows the surface of and/or the pores of the catalyst-supporting carbon to be coated with a thin coat of a polymer electrolyte, thereby making it possible to effectively use all the catalyst supported on the carbon, including the catalyst such as platinum in the pores.

Preferably, the electrolyte monomer or electrolyte monomer precursor undergoes living polymerization so as to allow the molecular weight of the resultant polymer to fall into an optimum range. Accordingly, living radical polymerization initiator or living anion polymerization initiator is preferably used as the above described polymerization initiator. Preferred examples of living radical polymerization initiators include, not limited to, 2-bromoisobutyryl bromide. Examples of electrolyte monomers applicable include: not limited to, unsaturated compounds containing a sulfonic acid group, phosphoric acid group, carboxylic acid group or ammonium group. Examples of electrolyte monomer precursor applicable include: not limited to, unsaturated compounds that can form a sulfonic acid group, phosphoric acid group, carboxylic acid group or ammonium group when undergoing hydrolysis after polymerization; and unsaturated compounds that can introduce a sulfonic acid group, phosphoric acid group, carboxylic acid group or ammonium group after polymerization. Of these unsaturated compounds, ethyl styrenesulfonate is preferable.

In the present invention, it is preferable, from the viewpoint of the efficiency of the catalyst used, that in the step of polymerizing the electrolyte monomer or electrolyte monomer precursor, the ratio of the electrolyte weight to the sum of the electrolyte weight and the catalyst-supporting carbon weight is less than 10%. The above described ratio of the electrolyte weight to the sum of the electrolyte weight and the catalyst-supporting carbon weight can be set to a prescribed one by controlling the concentration of the electrolyte monomer or the concentration of the electrolyte monomer precursor. In catalyst layers for fuel cells, considerations ought to be given from the viewpoint of supplying electrons to the catalyst as well as from the viewpoint of supplying protons to the catalyst. The supply of protons is promoted by the present invention, but promoting the supply of protons alone is not sufficient. Consideration of platinum utilization shows that it is preferable, from the viewpoint of supplying electrons, that the ratio of the electrolyte weight to the sum of the electrolyte weight and the catalyst-supporting carbon weight is less than 10%.

Although the catalyst-supporting support of the present invention can be widely applied to various types of catalysts that employ carbon support, it is particularly preferably used for electrodes for fuel cells. Thus, a third aspect of the present invention is a method for producing an electrode for a fuel cell made up of catalyst-supporting carbon and an electrolyte polymer, which enables the polymer electrolyte and the catalyst to meet on the surface of the carbon with pores and in the nano-size pores in the carbon.

This contributes to improving the catalyst utilization in the electrode for a fuel cell obtained by the present invention. And in the electrode for a fuel cell that includes an ion-exchange resin and carbon particles, the catalyst having gone down to the depth of the nano-size pores in the carbon particles is allowed to form a three-phase boundary, whereby the existing catalyst can be used for the reactions while avoiding its wasting. As described above, electrolyte monomer, which is in the monomer state, and catalyst-supporting support are first mixed and then polymerized; as a result, ion-exchange paths are formed even in the spaces of the pores of the support, whereby the catalyst utilization is improved and the efficiency of the power generation is increased even if the materials used are the same.

The method for producing an electrode for a fuel cell using the above described catalyst-supporting carbon is not limited to any specific one, and it can employ the above described catalyst-supporting support as it is. If desired, the method may further include: a step of protonating the polymer portion of the catalyst-supporting support with an electrolyte monomer precursor polymerized on its surface and/or in its pores; a step of drying the protonated product and dispersing the dried protonated product in water; and a step of filtering the dispersion. Likewise, the method may further include: a step of forming the catalyst support with an electrolyte monomer polymerized on its surface and in its pores into catalyst paste; and a step of forming the catalyst paste into a prescribed shape.

A fourth aspect of the present invention is a highly hydrophilic support itself made up of a carbon support and an electrolyte polymer, characterized in that there exists a polymer electrolyte on the surface of and/or in the pores of the carbon with pores. The catalyst-supporting support of the present invention is highly hydrophilic because its surface is coated with a thin coat of polymer electrolyte. Thus, it does not aggregate, but exhibits high dispersibility in water and thus can be widely applied for the powder technology field such as various types of catalyst supports and toner for copiers.

A fifth aspect of the present invention is a catalyst-supporting support itself made up of catalyst-supporting carbon and an electrolyte polymer, characterized in that there exist polymer electrolyte and catalyst on the surface of and/or in the pores of the carbon with pores. This allows the surface of and/or the pores of the catalyst-supporting carbon to be coated with a thin coat of a polymer electrolyte, thereby making it possible to effectively use all the catalyst supported on the carbon, including the catalyst such as platinum in the pores.

As described above, to allow the molecular weight of the resultant polymer to fall into an optimum range, preferably the electrolyte monomer undergoes living polymerization. Accordingly, living radical polymerization initiator or living anion polymerization initiator is preferably used to produce polymerization initiation sites. Preferred examples of living radical polymerization initiators include, not limited to, 2-bromoisobutyryl bromide. Examples of electrolyte monomers applicable include: not limited to, unsaturated compounds containing a sulfonic acid group, phosphoric acid group, carboxylic acid group or ammonium group. Examples of electrolyte monomer precursor applicable include: not limited to, unsaturated compounds that can form a sulfonic acid group, phosphoric acid group, carboxylic acid group or ammonium group when undergoing hydrolysis after polymerization. Of these unsaturated compounds, ethyl styrenesulfonate is preferable.

The catalyst-supporting support of the present invention can be widely applied to various types of catalysts using a carbon support, and it is particularly preferably used for an electrode for a fuel cell. Thus, the fourth aspect of the present invention is an electrode for a fuel cell made up of catalyst-supporting carbon and an electrolyte polymer. This enables polymer electrolyte and catalyst to exist on the surface of carbon with pores and/or in the nano-size pores in carbon with pores.

A sixth aspect of the present invention is a polymer electrolyte fuel cell including an anode, a cathode, and a polymer electrolyte membrane arranged between the anode and the cathode, characterized in that the fuel cell includes the above described electrode for a fuel cell as the anode and/or the cathode.

Including the above described electrode of the present invention, which is high in catalyst efficiency and has excellent electrode characteristics, makes it possible to make up a polymer electrolyte fuel cell that produces high cell output. Further, since the electrode of the present invention is high in catalyst efficiency and excels in durability, the polymer electrolyte fuel cell of the present invention which includes the electrode makes it possible to stably obtain high cell output over a long period of time.

The present invention has enabled polymer electrolyte to be synthesized (produced) uniformly on the surface and in the pores of a carbon support and thus improved the hydrophilic nature of the carbon support. Further, the present invention has enabled polymer electrolyte to be synthesized (produced) uniformly on the surface and in the pores of catalyst-supporting carbon and thus decreased the amount of non-active catalyst which does not come in contact with the electrolyte.

### BRIEF DESCRIPTION OF THE DRAWINGS

FIG. 1A is a schematic view of a catalyst-supporting support of the present invention which is made up of catalyst-supporting carbon and an electrolyte polymer;

FIG. 1B is a schematic view of a conventional catalyst-supporting support;

FIG. 2 is a reaction scheme in accordance with an example of the present invention;

FIG. 3 is a graph showing the result of current density—voltage curve obtained by a fuel cell power generation test; and

FIG. 4 is a graph showing the effective area per unit amount of Pt added vs. the ratio of electrolyte weight (%).

### BEST MODE FOR CARRYING OUT THE INVENTION

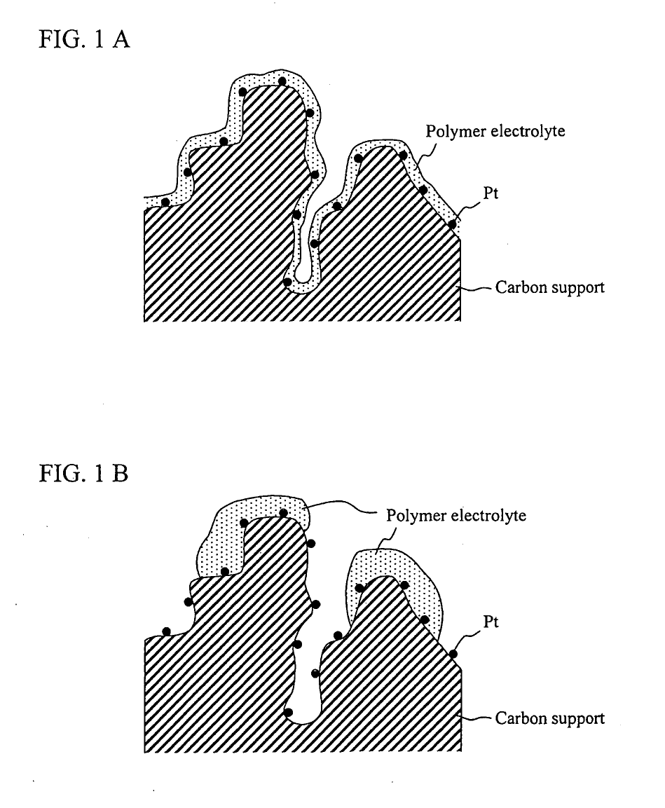

In the following the present invention will be described taking a catalyst-supporting support for example. Schematic views of catalyst-supporting supports of the present invention and of conventional art are shown in FIG. 1. FIG. 1A shows a catalyst-supporting support of the present invention which is made up of catalyst-supporting carbon, for example, platinum-supporting carbon and electrolyte polymer. In the catalyst-supporting support, catalyst exists on the surface and/or in the pores of the carbon, and besides, polymer electrolyte also exists on the surface and in the pores of the carbon uniformly in the form of a thin coat. Thus, a three-phase boundary at which reaction gas, catalyst and electrolyte meet can be sufficiently ensured in the carbon, and thus the catalyst efficiency can be increased.

Specifically, the electrodes for a fuel cell of the present invention are produced in the steps of: introducing a polymerization initiator to the outermost surface of carbon; and mixing electrolyte monomer, as a raw material for polymer electrolyte, with the polymerization initiator to polymerize the electrolyte monomer so that a thin coat of polymer electrolyte is formed uniformly on the surface and/or in the nano-size pores of the carbon support. Thus, monomer which is to be an electrolyte is fixed on the surface of carbon. Since the monomer has a molecular weight of several tens to several hundreds, it can get into the depth of the nano-size pores. And if the monomer is polymerized in the depth of the pores, a lot of catalyst having gone down in the pores and having not come in contact with electrolyte can be used, whereby the electrodes for a fuel cell can provide better performance with a decreased amount of catalyst.

FIG. 1B, on the other hand, shows a catalyst-supporting support of the conventional art, which is produced by: fully dispersing catalyst-supporting carbon and a polymer electrolyte solution, such as Nafion solution, in an appropriate solvent; forming the dispersion into a thin film; and drying the thin film. As shown in the figure, even though catalyst exists in the depth of the pores of the carbon, the polymer electrolyte is coated on only part of the carbon surface. Since the catalyst-supporting support is coated thick on only part of the carbon surface, the existence of three-phase boundaries at which reaction gas, catalyst and electrolyte meet is insufficient, and therefore the catalyst efficiency cannot be increased.

In the above described conventional method for producing a catalyst-supporting support, Nafion in the polymer state is dispersed on catalyst-supporting carbon. In the catalyst-supporting carbon, carbon having a specific surface area as large as 1000 m²/g has nano-size pores and catalyst particles as small as 2 to 3 nm in diameter, which is in the order of several molecules, are supported in the nano-size pores. Accordingly, the number of the pores which molecules with a molecular weight of several thousands to several ten thousands, such as polymer electrolyte, can get into is limited. And most of the catalyst having gone down in the pores of the carbon cannot come into contact with the electrolyte and does not contribute to the reaction. The utilization of the catalyst supported on carbon has been said to be about 10%, and in the system in which expensive platinum or the like is used as catalyst, the increase in the catalyst utilization has been a problem for many years.

The living polymerization used in the present invention is polymerization in which the propagation end groups are invariably active or pseudo-living polymerization in which the deactivated propagation end groups and the activated propagation end groups meet at equilibrium. The living polymerization defined in the present invention also includes both of the above described types of polymerization. Although known living polymerization includes: living radical polymerization and living anion polymerization, from the viewpoint of polymerization operatability, living radical polymerization is preferable.

Living radical polymerization is radical polymerization in which the activity of the polymerization end groups is not lost, but maintained. Living radical polymerization has been actively studied in recent years by various research groups. Examples of living radical polymerization studied include: living radical polymerization using a chain transfer agent such as polysulfide; living radical polymerization using a radical scavenger such as cobalt porphyrin complex or nitroxide compound; and atom transfer radical polymerization (ATRP) using an organic halogenide or the like as an initiator and a transition metal complex as a catalyst. There are no limits to which method should be used in the present invention; however, living radical polymerization which uses a transition metal complex as a catalyst and an organic halogenide containing one or more halogen atoms as an initiator is recommended.

In the above described types of living radical polymerization, generally polymerization rate is very high; polymerization progresses in the manner of living polymerization, though it is radical polymerization in which termination such as coupling reaction between radicals is likely to occur; polymer is obtained whose molecular weight distribution is narrow and Mw/Mn=1.1 to 1.5; and the molecular weight of polymer can be freely controlled by the ratio of the amount of the monomer introduced to the amount of the initiator introduced.

In the following, preferred embodiments of electrodes for a fuel cell of the present invention and a polymer electrolyte fuel cell including the above electrodes will be described.

Although the electrodes for a polymer electrolyte fuel cell of the present invention each include a catalyst layer, preferably the electrodes are made up of a catalyst layer and a gas diffusion layer arranged adjacent to the catalyst layer. Examples of materials used for making up the gas diffusion layer include electron conducting porous materials (e.g. carbon cloth, carbon paper).

Examples of carbon used for supporting catalyst include carbon black particles. Examples of catalyst particles used include metals of platinum group such as palladium.

The present invention exerts its effect particularly when the specific surface area of the carbon used exceeds 200 m²/g. Specifically, in carbon having such a large specific surface area, there exist a lot of nano-size pores on its surface and thus it has a good gas diffusibility; but on the other hand, catalyst particles existing in the nano-size pores do not come in contact with the polymer electrolyte and thus do not contribute to the reaction. In this respect, in the present invention, the catalyst particles dispersed in the polymer electrolyte come in contact with the polymer electrolyte even in the nano-size pores and are thus effectively used. In other words, the present invention enables the improvement of gas diffusibility while maintaining the reaction efficiency.

In the following, the catalyst-supporting support of the present invention and a polymer electrolyte fuel cell including the catalyst-supporting support will be described in detail by examples.

### EXAMPLE 1

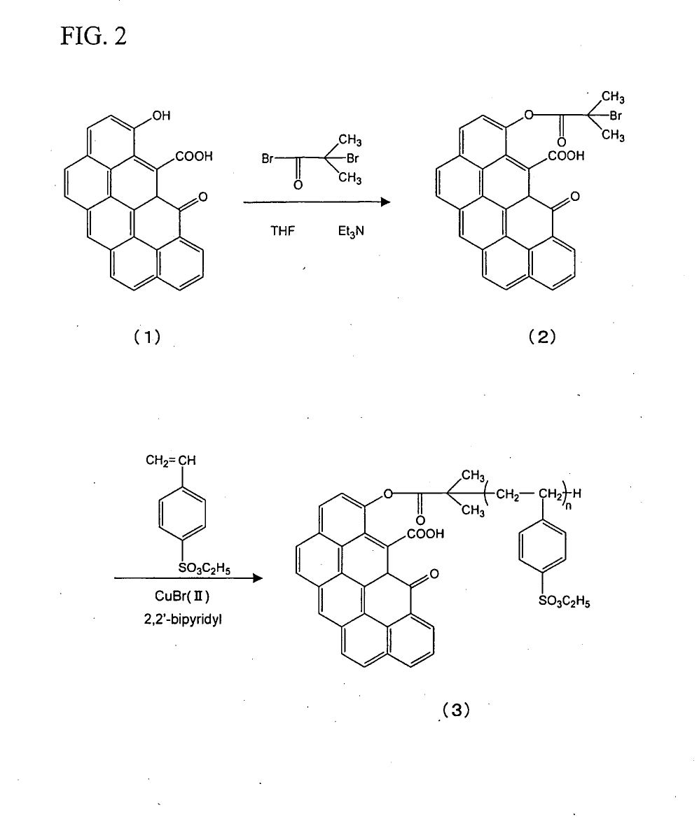

The reaction scheme of this example is shown in FIG. 2.

First, functional groups, which were to be a living radical polymerization initiator, were introduced to platinum-supporting carbon particles. Catalyst carbon was prepared by allowing 40 wt % of Pt to be supported on 100 wt % of VULCAN XC 72 (support carbon). The support carbon (I) had a hydroxyl group, a carboxyl group, a carbonyl group etc. on its carbon condensed ring. Of these groups, the hydroxyl group reacted with the initiator of the living radical polymerization. Although the catalyst carbon originally has a hydroxyl group, to adjust the number of hydroxyl groups, it may undergo nitric acid treatment. The functional groups, which were to be a living radical polymerization initiator, were introduced to the carbon particles by allowing 2-bromoisobutyryl bromide to react with the phenolic hydroxyl groups the carbon particles had in THF in the presence of a base (triethylamine) (2).

Then, polymer having a sulfonic acid group on its side chain was grafted onto each platinum-supporting carbon particle. The platinum- supporting carbon particles (2) obtained by the above described reaction that had functional groups, which were to be the initiation sites of the living radical polymerization, having been introduced thereto were put into a round flask. After performing deoxygenation by blowing argon gas in the flask, ethyl styrenesulfonate (ETSS, by Tosoh Corporation) was poured little by little. After continuing deoxygenation, a transition metal compound as a catalyst was added, if desired, together with its ligand. After fully stirring, the mixture was warmed up and allowed to initiate living radical polymerization in the absence of a solvent to obtain platinum-supporting carbon particles grafted with polymer having an ethylsulfonic acid group on its side chain (3). The polymerization degree n of ethyl styrenesulfonate, as a repeating unit, can be freely controlled by the amount of ethyl styrenesulfonate introduced and is, not limited to, 5 to 100 and preferably about 10 to 30.

A dispersion of platinum-supporting carbon particles grafted with polymer having an ethylsulfonic acid group on its side chain was prepared, and sodium iodide was put into the dispersion to hydrolyze/protonate the ethylsulfonic acid group into sodium sulfonate. Then the sodium of the sodium sulfonate was replaced by hydrogen using sulfuric acid to obtain a sulfonic acid group. The obtained catalyst-supporting carbon particles were dried, and the dried catalyst-supporting carbon particles were dispersed in water. After that, 10-fold or more dilution of the dispersion was made with hexane, and the diluted dispersion was filtered to obtain a catalyst layer for a fuel cell.

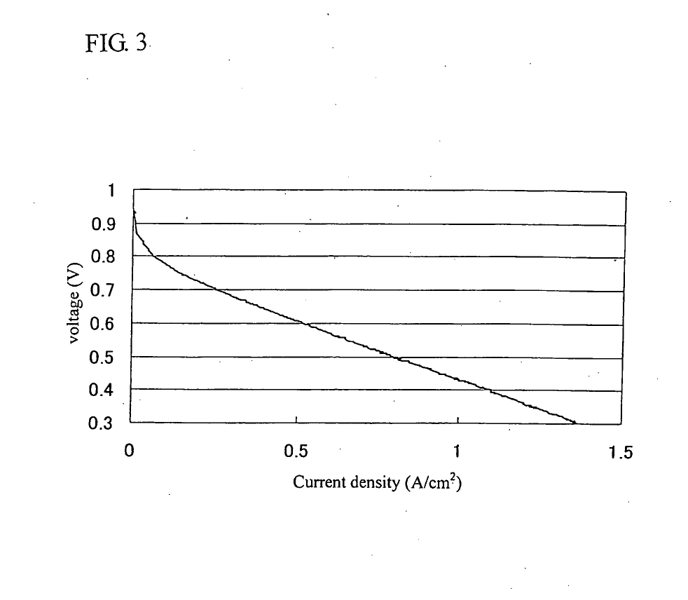

The synthesized catalyst layer was joined to a fuel cell electrolyte membrane to produce an MEA. The MEA was used to conduct a fuel cell power generation test. The resultant current density—voltage curve is shown in FIG. 3. The result shown in FIG. 3 proved that the use of the catalyst-supporting carbon of the present invention made it possible to obtain an MEA having a good performance.

### EXAMPLE 2

Materials with different ratios of the electrolyte weight to the sum of the electrolyte weight and the catalyst-supporting carbon weight were prepared by varying the concentration of the monomer (ethyl styrenesulfonate) in the polymerization step described in the above example 1. The ratio of the electrolyte weight was obtained by potentiometric titration of a sulfonic acid group.

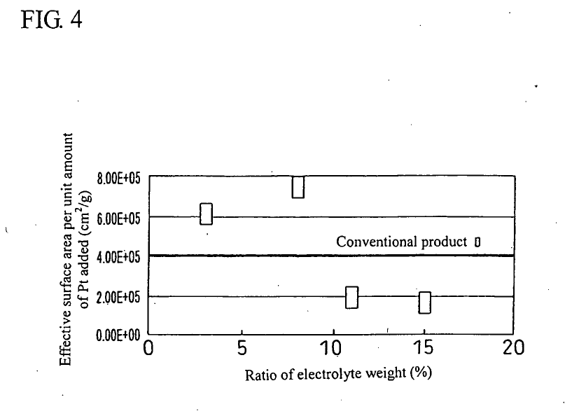

The effective area of the obtained catalyst layer per unit amount of platinum added was obtained by cyclic voltammetry. The result is shown in FIG. 4.

The result shown in FIG. 4 reveals that the catalytic performance of the catalyst layer is excellent when the ratio of the electrolyte weight to the sum of the electrolyte weight and the catalyst-supporting carbon weight is less than 10%.

The reason has not been fully clarified yet why the catalytic performance is excellent when the ratio of the electrolyte weight to the sum of the electrolyte weight and the catalyst-supporting carbon weight is less than 10%. However, SEM photographs have confirmed that the thickness of the coating of the polymer electrolyte increases with the increase in the ratio of the electrolyte weight. Probably, the increase in the thickness of the coating makes it hard to bring support particles into contact with each other, resulting in lowering the electron conductivity, whereby the catalytic performance deteriorates.

### INDUSTRIAL APPLICABILITY

According to the present invention, a three-phase boundary at which reaction gas, catalyst and electrolyte meet can be sufficiently ensured in carbon, and thus the utilization of the catalyst can be improved. The application of the present invention to a fuel- cell enables electrode reactions of the fuel cell to progress effectively and the efficiency of power generation of the fuel cell to be increased. Further, the application of the present invention makes it possible to provide an electrode having excellent characteristics and a polymer electrolyte fuel cell including the above electrode with which high output can be obtained. Thus, the catalyst-supporting support of the present invention can be widely applied to various types of catalysts that employ a carbon support and particularly preferably applied to an electrode for a fuel cell. This contributes to the spread of fuel cells.

1. A method for producing a highly hydrophilic support made up of a carbon support and an electrolyte polymer, characterized in that the method comprises a step of introducing a functional group, which is to be a polymerization initiator, into the surface and/or the pores of a carbon support with pores; and a step of introducing an electrolyte monomer or electrolyte monomer precursor into the surface and/or the pores of the carbon support to polymerize the electrolyte monomer or electrolyte monomer precursor using the polymerization initiator as a polymerization initiation site.

2. The method for producing a highly hydrophilic support according to claim 1, characterized in that the polymerization initiator is a living radical polymerization initiator or living anion polymerization initiator.

3. The method for producing a highly hydrophilic support according to claim 2, characterized in that the living radical polymerization initiator is 2-bromoisobutyryl bromide.

4. The method for producing a highly hydrophilic support according to any one of claims 1 to 3, characterized in that in the step of polymerizing an electrolyte monomer or electrolyte monomer precursor, the ratio of the electrolyte weight to the sum of the electrolyte weight and the catalyst-supporting carbon weight is less than 10%.

5. The method for producing a highly hydrophilic support according to claim 4, characterized in that the ratio of the electrolyte weight to the sum of the electrolyte weight and the catalyst-supporting carbon weight is controlled by the concentration of the electrolyte monomer or the concentration of the electrolyte monomer precursor in the step of polymerizing an electrolyte monomer or electrolyte monomer precursor.

6. The method for producing a highly hydrophilic support according to any one of claims 1 to 5, characterized in that the method further comprises a step of hydrolyzing the polymer or introducing an ion-exchange group to the polymer after polymerizing the electrolyte monomer precursor.

7. The method for producing a highly hydrophilic support according to any one of claims 1 to 6, characterized in that the electrolyte monomer precursor is ethyl styrenesulfonate.

8. A method for producing a catalyst-supporting support made up of catalyst-supporting carbon and an electrolyte polymer, characterized in that the method comprises a step of allowing carbon with pores to support a catalyst; a step of introducing a functional group, which is to be a polymerization initiator, into the surface and/or the pores of the catalyst-supporting carbon; and a step of introducing an electrolyte monomer or electrolyte monomer precursor into the surface and/or the pores of the catalyst-supporting carbon to polymerize the electrolyte monomer or electrolyte monomer precursor using the polymerization initiator as a polymerization initiation site.

9. The method for producing a catalyst-supporting support according to claim 8, characterized in that the polymerization initiator is a living radical polymerization initiator or living anion polymerization initiator.

10. The method for producing a catalyst-supporting support according to claim 9, characterized in that the living radical polymerization initiator is 2-bromoisobutyryl bromide.

11. The method for producing a catalyst-supporting support according to any one of claims 8 to 10, characterized in that in the step of polymerizing an electrolyte monomer or electrolyte monomer precursor, the ratio of the electrolyte weight to the sum of the electrolyte weight and the catalyst-supporting carbon weight is less than 10%.

12. The method for producing a catalyst-supporting support according to claim 11, characterized in that the ratio of the electrolyte weight to the sum of the electrolyte weight and the catalyst-supporting carbon weight is controlled by the concentration of the electrolyte monomer or the concentration of the electrolyte monomer precursor in the step of polymerizing an electrolyte monomer or electrolyte monomer precursor.

13. The method for producing a catalyst-supporting support according to any one of claims 8 to 12, characterized in that the method further comprises a step of hydrolyzing the polymer or introducing an ion-exchange group to the polymer after polymerizing the electrolyte monomer precursor.

14. The method for producing a catalyst-supporting support according to any one of claims 8 to 13, characterized in that the electrolyte monomer precursor is ethyl styrenesulfonate.

15. A method for producing an electrode for a fuel cell, characterized in that the catalyst-supporting support according to any one of claims 8 to 14 is used for an electrode for a fuel cell.

16. The method for producing an electrode for a fuel cell according to claim 15, characterized in that the method further comprises: a step of protonating the polymer portion of the catalyst-supporting support with an electrolyte monomer precursor polymerized on its surface and/or in its pores; a step of drying the protonated product and dispersing the dried protonated product in water; and a step of filtering the dispersion.

17. The method for producing an electrode for a fuel cell according to claim 15, characterized in that the method further comprises: a step of forming the catalyst-supporting support with an electrolyte monomer or electrolyte monomer precursor polymerized on its surface and/or in its pores into catalyst paste; and a step of forming the catalyst paste into a prescribed shape.

18. A highly hydrophilic support made up of a carbon support and an electrolyte polymer, characterized in that there exists a polymer electrolyte on the surface of and/or in the pores of the carbon with pores.

19. The highly hydrophilic support according to claim 18, characterized in that the ratio of the polymer electrolyte weight to the sum of the polymer electrolyte weight and the catalyst-supporting carbon weight is less than 10%.

20. The highly hydrophilic support according to claim 18 or 19, characterized in that the electrolyte polymer is a product obtained by polymerizing an electrolyte monomer or electrolyte monomer precursor on the surface of and/or in the pores of the carbon support as a polymerization initiation site.

21. The highly hydrophilic support according to claim 20, characterized in that the polymerization initiation site is formed by a living radical polymerization initiator or living anion polymerization initiator.

22. The highly hydrophilic support according to claim 21, characterized in that the living radical polymerization initiator is 2-bromoisobutyryl bromide.

23. The highly hydrophilic support according to any one of claims 18 to 22, characterized in that the electrolyte monomer is ethyl styrenesulfonate.

24. A catalyst-supporting support made up of catalyst-supporting carbon and an electrolyte polymer, characterized in that there exists a polymer electrolyte and a catalyst on the surface of and/or in the pores of the carbon with pores.

25. The catalyst-supporting support according to claim 24, characterized in that the ratio of the polymer electrolyte weight to the sum of the polymer electrolyte weight and the catalyst-supporting carbon weight is less than 10%.

26. The catalyst-supporting support according to claim 24 or 25, characterized in that the electrolyte polymer is a product obtained by polymerizing an electrolyte monomer or electrolyte monomer precursor on the surface of and/or in the pores of the catalyst-supporting carbon as a polymerization initiation site.

27. The catalyst-supporting support according to claim 26, characterized in that the polymerization initiation site is formed by a living radical polymerization initiator or living anion polymerization initiator.

28. The catalyst-supporting support according to claim 27, characterized in that the living radical polymerization initiator is 2-bromoisobutyryl bromide.

29. The catalyst-supporting support according to any one of claims 24 to 28, characterized in that the electrolyte monomer precursor is ethyl styrenesulfonate.

30. An electrode for a fuel cell, characterized in that the catalyst-supporting support according to any one of claims 24 to 29 is used for an electrode for a fuel cell.

31. A polymer electrolyte fuel cell, comprising an anode, a cathode, and a polymer electrolyte membrane arranged between the anode and the cathode, characterized in that the fuel cell comprises the electrode for a fuel cell according to claim 30 as the anode and/or the cathode.
